(19) United States
(12) Patent Application Publication
(10) Pub. No.: US 2015/0379647 A1
(43) Pub. Date: Dec. 31, 2015

(54) SUGGESTED ACCOUNTS OR LEADS

(71) Applicant: Linkedln Corporation, Mountain View, CA (US)

(72) Inventors: Abhishek Gupta, San Francisco, CA (US); Tingting Cui, Mountain View, CA (US); Zang Li, Milpitas, CA (US); Anmol Bhasin, Los Altos, CA (US); Sachin Rekhi, Mountain View, CA (US)

(21) Appl. No.: 14/479,127

(22) Filed: Sep. 5, 2014

Related U.S. Application Data
(60) Provisional application No. 62/019,374, filed on Jun. 30, 2014.

(51) Int. Cl. G06Q 50/00; G06Q 30/00

(52) U.S. Cl. CPC G06Q 50/01; G06Q 30/016

(57) ABSTRACT

In an example embodiment, a request to onboard a first user to a sales tool is received. Then usage information related to the first user is retrieved from a social networking service. One or more entities may then be generated in the sales tool based on the usage information from the social networking service. A score can be calculated for each of the one or more entities, the score indicating a likelihood that the first user will wish to receive insights regarding the one or more entities from the sales tool. Then the one or more entities are ranked based on the calculated score for each of the one or more entities. The one or more entities can be added as entries in the sales tool based on the ranking.

### RELATED APPLICATIONS

This application claims priority to U.S. Provisional Application No. 62/019,374, entitled “Suggested Accounts or Leads”, filed Jun. 30, 2014, which is incorporated by reference herein in its entirety.

### TECHNICAL FIELD

This application relates to the technical fields of computer software and, in one example embodiment, to suggesting accounts or leads in a sales tool.

### BACKGROUND

CRM is a system used to manage an entity's interactions with current and future customers. It often involves utilizing technology to organize, automate, and synchronize sales, marketing, customer service, and/or technical support. The general goal of CRM systems is to enable entities to better manage their customers through the introduction of reliable systems, processes, and procedures for interacting with those customers. CRM systems are also used to manage business contacts, clients, contract wins, sales leads, etc.

From the salesperson perspective, there are a number of different tools providing sales intelligence that are available to salespeople. There is a need, however, for a system that could suggest potential accounts and/or leads to salespeople within a sales tool when the salesperson is starting to utilize the sales tool.

### BRIEF DESCRIPTION OF DRAWINGS

Embodiments are illustrated by way of example and not limitation in the figures of the accompanying drawings, in which like reference numbers indicate similar elements and in which:

FIG. 1 is a block diagram illustrating a system for CRM-based discovery of accounts and contacts, in accordance with an example embodiment.

FIG. 2 is a block diagram illustrating an onboarding module, in accordance with an example embodiment.

FIG. 3 is a block diagram illustrating a social networking information analyzer, in accordance with an example embodiment.

FIG. 4 is a flow diagram illustrating a method for suggesting entries in a sales tool in accordance with an example embodiment.

FIG. 5 is a screen capture illustrating a welcome screen of a sales tool in accordance with an example embodiment.

FIG. 6 is a screen capture illustrating a data synchronization screen of the sales tool in accordance with an example embodiment.

FIG. 7 is a screen capture illustrating a first user input screen of the sales tool in accordance with an example embodiment.

FIG. 8 is a screen capture illustrating a second user input screen of the sales tool in accordance with an example embodiment.

FIG. 9 is a screen capture illustrating a suggested accounts screen of the sales tool in accordance with an example embodiment.

FIG. 10 is a block diagram illustrating a mobile device, according to an example embodiment.

FIG. 11 is a block diagram of machine in the example form of a computer system within which instructions, for causing the machine to perform any one or more of the methodologies discussed herein, can be executed.

### DETAILED DESCRIPTION

### Overview

The present disclosure describes, among other things, methods, systems, and computer program products, which individually provide functionality for providing a sales tool. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a sales tool is provided that automatically suggests accounts and/or leads to a user (typically a salesperson) during an onboarding process. Prospecting for new leads and accounts can then be simplified based on look-alike modelling, and sales professionals can be proactively notified of actionable insights on target accounts and leads.

In an example embodiment, the sales tool (and/or other sales tools) may be augmented by providing a mechanism to automatically import data from a CRM system and use this data for sales analysis and recommendations. For example, information about accounts and contacts for a salesperson can be automatically imported from the CRM system and applied in the sales tool to provide for recommendations of potential leads for new accounts and leads. There are many salespeople, however, who either do not utilize CRM systems or whose CRM data is so sparse as to be unusable by itself to surface accounts and/or leads.

Thus, in a further example embodiment, new accounts and/or leads for a user can be deduced based on the user's actions on a social networking service, either in addition to or in lieu of information extracted from a CRM system.

As used herein, the term “or” may be construed in either an inclusive or exclusive sense. Similarly, the term “exemplary” merely means an example of something or an exemplar and not necessarily a preferred or ideal means of accomplishing a goal. For the purposes of this description, the phrase “an on-line social networking application” may be referred to as and used interchangeably with the phrase “an on-line social network” or merely “a social network.” It will also be noted that an on-line social network may be any type of an on-line social network such as, for example, a professional network, an interest-based network, or any on-line networking system that permits users to join as registered members. For the purposes of this description, registered members of an on-line social network may be referred to as simply members.

For purposes of this disclosure, a sales tool is any tool that can be used to provide sales-related information to a user. This may include a tool designed to present information about accounts and/or leads to the user so that the user can gain insight into the accounts and/or leads to help in communicating with the accounts and/or leads.

It should be noted that the terms “contacts” and “leads” both are intended to refer to individuals. In the CRM environment it is typical to refer to such individuals as contacts and the information pertaining to those individuals stored in the CRM system as contact information. In the sales tool as described in this disclosure, it is common to refer to such individuals as leads, and the information pertaining to those individuals stored in the sales tool as lead information. Thus, in order to maintain this nomenclature, the present disclosure will refer to individuals as contacts with respect to the CRM systems and leads with respect to the sales tool (or any other tool or non-CRM environment, such as in the social network service). For example, if information about an individual is imported from a CRM system to the sales tool, then the present disclosure may refer to it as importing a contact from the CRM system and saving it as a lead in the sales tool. Nevertheless, this is merely a nomenclature to remain consistent with usage in the field, and such terms shall be construed as interchangeable.

The process of getting a user set up in a sales tool is known as “onboarding”. This may include importing accounts and contacts from a CRM system to the sales tool, although this is not true in all embodiments. In an example embodiment, this onboarding may be performed in a tool that is integrated with an on-line social network to further leverage information across domains. Each member of an on-line social network is represented by a member profile (also referred to as a profile of a member or simply a profile). A member profile may be associated with social links that indicate that member's connection to other members of the social network. A member profile may also include or be associated with comments or endorsements from other members of the on-line social network, with links to other network resources such as, for example, publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Reputation scores may be computed based on information obtained from trusted sources, such as patent databases, publications databases, skills, endorsement of skills, or even enterprise contracts.

In addition to member profiles, there may be a number of different types of data stored by the social network site. Additionally, data from other data sources, such as audio and video content, email and business documents, calendars, text messages, etc. may also be accessed by the social network site. It would be helpful if all this data could be accessed in an efficient manner and that whatever features the social network site attempts to set up to access new data types or new data sources can be set up in an efficient manner.

The members of the social network need not be individuals, but can be businesses as well. For example, a company itself may be a member of the social network site and have a company profile page in the social network site, while employees of the company may each individually be members and have their own member pages, perhaps linked to the company profile page.

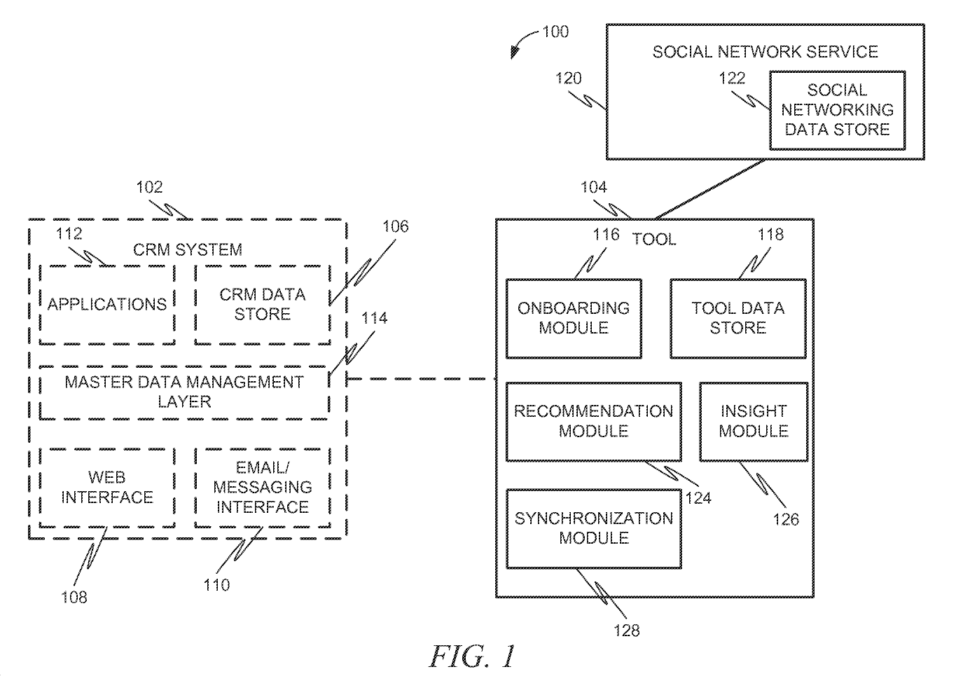

FIG. 1 is a block diagram illustrating a system 100 for CRM-based discovery of accounts and contacts, in accordance with an example embodiment. The system 100 may include a CRM system 102 and a tool 104. The CRM system 102 is depicted in dashed lines to signify that the inclusion of the CRM system 102 is optional.

The tool 104 may be, for example, a sales tool that provides various sales insights. The CRM system 102 may include a CRM data store 106 that stores information about accounts and contacts for various users. In an example embodiment, the CRM system 102 may be offered as a Software as a Service (SaaS) component and thus the system may be stored on a server or distributed among multiple servers. However, in some example embodiments the CRM system 102 and/or the CRM data store 106 may be located on a non-server computer such as a desktop computer, laptop computer, or mobile device. The CRM system 102 may include a web interface 108 to allow users to interact with the CRM system 102 via a web browser. The CRM system 102 may also include an email/messaging interface 110 that may interface with various other programs such as email or messaging clients to exchange information related to the CRM tasks. The CRM system 102 can also include one or more marketing applications 112. A master data management layer 114 can be used to manage in all of the components in the CRM system 102.

The tool 104 may include an onboarding module 116 that is used to set up new users and integrate their existing data into the tool 104. As with the CRM system 102, the tool 104 may be implemented as a SaaS component on a server or distributed among multiple servers, although embodiments are possible where the tool 104 is located on a non-server computer. The data can be stored in tool data store 118.

Also contained in the system 100 is a social network service 120. The social network service 120 may contain various social networking profiles and links between the profiles, stored in a social networking data store 122. As with the CRM system 102, the social networking service 120 may be implemented as a SaaS component on a server or distributed among multiple servers.

Returning to the tool 104, the onboarding module 116 can utilize usage information stored in the social networking data store 122 to aid in the onboarding process. This will be described in more detail below.

In an example embodiment, a recommendation module 124 can also be provided in the tool 104. The recommendation module 124 can recommend further accounts and/or leads from the social networking service 120 based on a variety of factors.

In an example embodiment, an insight module 126 can also be provided in the tool 104. The insight module 126 can act to provide insights about the accounts and/or leads associated with a user. This may include mining data in the social networking service 120 as well as information from the Internet in general (e.g., news searches, web page searches, etc.) to provide information about the accounts and/or leads that might be valuable to the user. For example, the user may be presented with recent news articles about an account, or a personal web page of a lead. This can enable the user to have, for example, information useful in breaking the ice or otherwise conversing with the account and/or lead, whether remotely (e.g., by email or phone) or in person (e.g., at a party).

In an example embodiment, a synchronization module 128 can also be provided in the tool 104. The synchronization module 128 can synchronize data between the tool data store 118 and the CRM data store 106.

There may, of course, be other modules contained within the tool 104 that are not described here to provide additional functionality to the user.

In an example embodiment, accounts and/or contacts are retrieved from a CRM system 102. Accounts include account-level information about entities such as companies or other organizations. Contacts include contact-level information about individuals. The system 100 can then attempt to map each account to a social network profile for a company or organization and map each contact to a social network profile for an individual. The system 100 is then able to generate insights within the tool 104 based on this information.

Most CRM systems 102 have both accounts and contacts. Accounts and contacts may generally be referred to as CRM entities.

In another example embodiment, either in addition to or in lieu of importing CRM entities, the onboarding module 116 acts to examine usage information from the social networking service 120 and deduce top accounts and/or leads that may be relevant to the user.

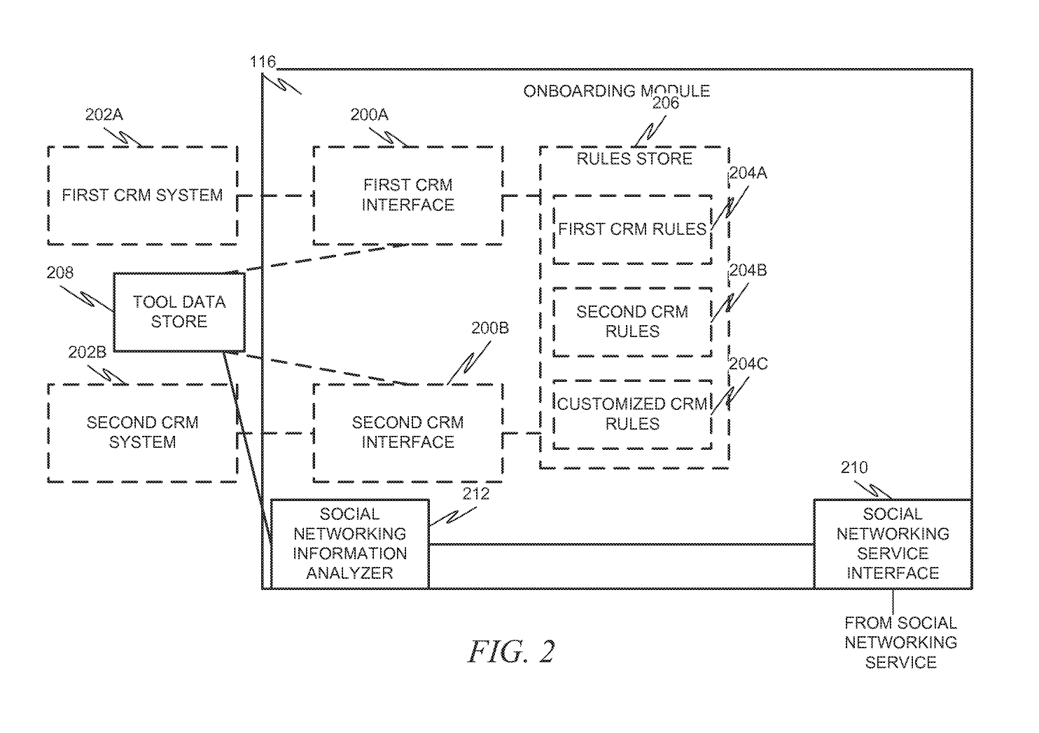

FIG. 2 is a block diagram illustrating an onboarding module, such as the onboarding module 116 of FIG. 1, in accordance with an example embodiment. The onboarding module 116 may include a first CRM interface 200A coupled to a first CRM system 202A. This first CRM system 202A may be, for example, the CRM system 102 of FIG. 1. The first CRM interface 200A may access first CRM rules 204A stored in a rule store 206. The rule store 206 may, for example, be part of tool data store 118 of FIG. 1, although in some example embodiments the rule store 206 may be a separate component. The first CRM rules 204A define a set of rules that are used to retrieve accounts and/or contacts from the first CRM system 202A.

In a further example embodiment, different rules can be established for different CRM systems 102. These different CRM systems 102 can be different instances of the same CRM architecture (perhaps customized differently, although perhaps alternatively merely containing different data). In another example embodiment, the different CRM systems 102 can be completely different CRM system architectures (e.g., CRM systems 102 offered by different manufacturers). As such, different interfaces may be provided for each different CRM system 102. The second CRM interface 200B may be used to retrieve accounts and/or contacts from the second CRM system 202B, utilizing second CRM rules 204B stored in the rule store 206.

While not pictured, there may be any number of different CRM interfaces and CRM rules provided to allow for retrieval of accounts and/or contacts from many different CRM systems 102. Each CRM interface may implement the corresponding rules retrieved from the rule store 206 along with procedures and functions tailored for retrieval of information from the particular corresponding CRM system 102. Thus, while the CRM rules may define a process of steps and ordering of steps to be performed when retrieving accounts and/or contacts from the CRM system 102, the CRM interface may further include its own procedures on how data is actually retrieved from the CRM system 102. This may include storing and using information such as CRM system database addresses, query protocols, data type protocols, and general communications protocols. It should be noted that there may be overlap between the what procedures could be defined in the CRM rules and what procedures could be defined in the corresponding CRM interfaces such that certain functionality may be contained in either a CRM rule or a CRM interface based on designer preference.

In an example embodiment, a company or user can specifically customize the CRM query or queries to further aid in the mapping. This may be performed by creating customized CRM rules 204C in the rule store 206, which then can be used by a specified CRM interface when that specified user (or users working for the specified company) are onboarded. Thus, for example, company XYZ can create customized CRM rules 204C to be used by the first CRM interface 200A when an employee of company XYZ is onboarded, causing the first CRM interface 200A to utilize different procedures to retrieve accounts and/or contacts from the first CRM system 202A than it would use if a user who wasn't an employee of company XYZ was onboarded and wanted to retrieve accounts and/or contacts from the first CRM system 202A (presumably in the latter case the first CRM interface 200A would utilize the first CRM rules 204A, or a different set of customized CRM rules (not pictured)).

All of the CRM entities extracted from the CRM systems 102 may be stored in the tool data store 208, which may then be used for mapping as will be described in more detail later.

The CRM-related components are depicted using dashed lines to indicate that they are optional.

A social networking service interface 210 can act to obtain usage information from a social networking service 120. This information may then be used by a social networking information analyzer 212 to determine one or more accounts and/or leads to suggest to a user. These account and/or lead suggestions may then also be stored in the tool data store 208.

It should be noted that, in some example embodiments, the social networking service interface 210 and social networking information analyzer 212 can act without the CRM interfaces 200A, 200B, rule store 206, or even the CRM systems 202A, 202B being present. In other words, it is not necessary for CRM entities to be stored in the tool data store 208 in order for the social networking information analyzer 212 to provide account and/or lead suggestions.

Turning now to the account and/or lead suggestions itself, it should be noted that the term “suggestion” should be interpreted broadly to cover any usage of an account and/or lead derived from the social networking service information. In one example embodiment, at least some of these account and/or lead suggestions are presented to the user during the onboarding process, and the user is able to accept or reject the suggested accounts and/or leads prior to them being associated with the user in the tool data store 208. In another example embodiment, the onboarding module 116 automatically adds at least some of these account and/or lead suggestions without user feedback or control. As such, the term “suggestions” should not be interpreted to be limited to embodiments where users are presented with results of the analysis. FIG. 2 depicts a case where a user is presented with at least some of the suggested accounts and/or leads and then accepted accounts and/or leads are added to the tool data store 208.

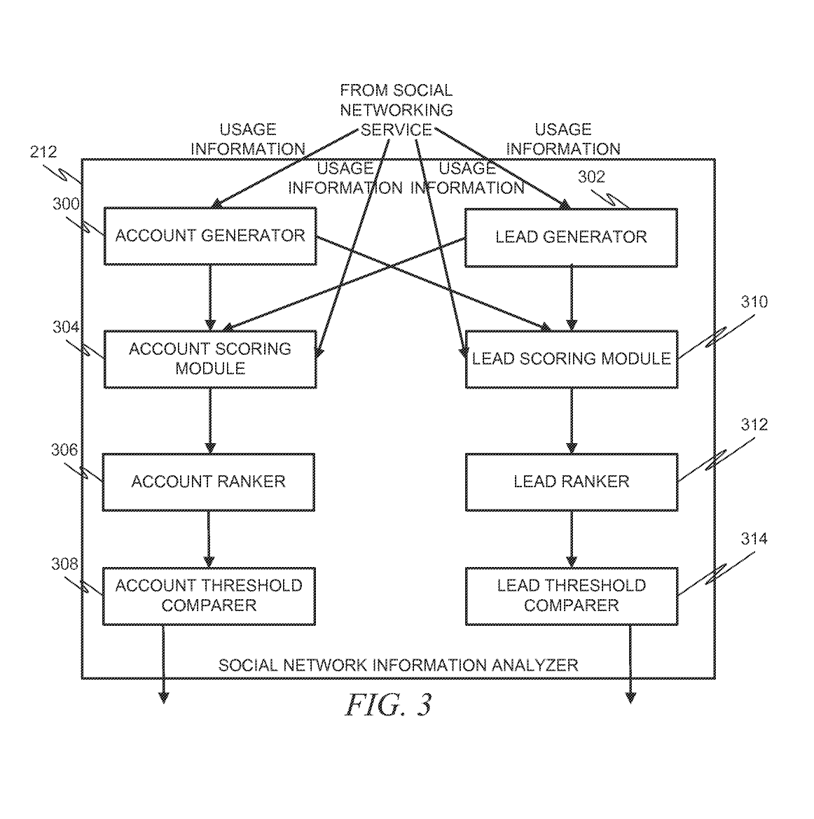

FIG. 3 is a block diagram illustrating a social networking information analyzer, such as the social networking information analyzer 212 of FIG. 2, in accordance with an example embodiment. An account generator 300 acts to generate accounts based on the social networking service usage information. This may be performed by searching the usage information for any interaction with a company or organization having a profile (or otherwise listed) in the social networking service. Various pieces of usage information may be examined to identify such companies or organizations. This may include, but is not limited to, identifying profile pages visited by the user and identifying companies or organizations of people with which the user has communicated within a communications platform operated by the social networking service 120 (such as an in-network email or messaging system). While most companies and organizations will have their own profile pages in the social networking service 120, this is not necessary in order for a company or organization to be generated as a potential account by the account generator 300. Specifically, embodiments are possible where a company or organization lacks a profile page but still is listed in other data in the social networking service 120, such as listed in individual employee profiles as a place where they work, or even, more remotely, mentioned in communications in the in-network communications platform.

The output of the account generator 300 is a list of potential accounts.

A lead generator 302 acts to generate leads based on the social networking usage information. This may be performed by searching the usage information for any interaction with a contact having a profile (or otherwise listed) in the social networking service 120. Various pieces of usage information may be examined to identify such contacts. This may include, but is not limited to, identifying profile pages visited by the user and identifying people with which the user has communicated within a communications platform operated by the social networking service 120 (such as an in-network email or messaging system). While most contacts will have their own profile pages in the social networking service 120, this is not necessary in order for a contact to be generated as a potential lead by the lead generator 302. Specifically, embodiments are possible where a contact lacks a profile page but still is listed in other data in the social networking service 120, such as being listed in a company or organization profile as an employee, or even, more remotely, mentioned in communications in the in-network communications platform.

An account scoring module 304 then acts to generate a score for each potential account generated by the account generator 300. The score signifies the likelihood that the user will have interest in adding the account to the tool data store 208 to be utilized by the tool to provide insights. The score may be based on a number of inputs. As depicted in FIG. 3, inputs may include both generated accounts from the account generator 300 and generated leads from the lead generator 302. This is because user interaction with individual leads can affect the score for an account associated with the leads. For example, even if a user never interacts with a profile for a particular company, if the user interacts a lot with individual employees of the company, the account scoring module 304 may still assign a high score to the company because the user is likely to have interest in gaining insights into the company.

While not pictured in FIG. 3, information may be obtained from other inputs as well and used to affect the score assigned by the account scoring module 304. One example of another input is general Internet information, which may be used to, for example, filter or weight usage information on companies and/or contacts. For example, if a company is mentioned prominently in recent news articles, usage information showing interaction with employees of that company may be weighted higher than usage information showing interaction with employees of a company that is not mentioned prominently in recent news articles.

Another example of an additional input from which information may be obtained is usage information from partner services. A partner service may have information that, for example, is not available to the social networking service 120. For example, a search engine service may partner with the social networking service 120 and/or the tool and provide general search engine result information which can be used to, for example, filter or weight usage information on companies and/or contacts.

Thus, the account scoring module 304 can utilize input from a number of different sources to provide the score to each potential account generated by the account generator 300. In addition to the source of the input to the account scoring module 304 being varied, the type of input information can be varied as well. In the case of social networking service usage information, for example, the information may include an identification of profiles visited by the user, the amount of time the user spent visiting each profile, the number of times the user visited each profile, the actions taken by the user within the social networking service 120 while viewing the profile (e.g., clicking on certain fields or links), identifications of communications sent to or from the potential accounts and/or potential contacts, the number of times such communications were sent or received, the amount of time the user spent reading or writing such communications, etc.

In an example embodiment, the score can be calculated in a manner that varies based on the user. For example, certain users may have certain characteristics that might make certain types of information more relevant to the scoring of how likely the user is to want to get insights regarding a certain account. As an example, information about the user obtained by a user profile may indicate that the user is a VP of sales. The system may determine that VPs of sales are more likely to want to get insights about profiles they have viewed briefly than users having different job titles (who may request more time to be spent viewing a profile before insights become relevant). As such, the weighting of the inputs and/or scoring can be based, at least partially, on user-specific information.

In one example embodiment, the user is explicitly asked for inputs that may be relevant to customizing the scoring and thus affecting which accounts to suggest (and/or the ranking in which to suggest them). For example, the user may be asked which regions of the country are important to them, or what type of seniority level matters most to them. This kind of information could then be used to help determine the likelihood that the user will wish to be provided with insights regarding an account and/or lead.

The output of the account scoring module 304 is a set of scores for the potential accounts generated by the account generator 300. These scores may then be sent to an account ranker 306, which then may place the potential accounts in order based on the scores. Thus, accounts with scores reflecting a higher likelihood of user interest in insights for the account are ranked higher than accounts with scores reflecting a lower likelihood of user interest in insights for the account.

An account threshold comparer 308 can then take these rankings and compare them to a threshold to determine a final list of suggested accounts. This threshold may be specified in a number of different ways. In one example embodiment, the threshold reflects a particular score which, if the account score meets or exceeds the particular score, the corresponding account is suggested. Thus, the threshold may be absolute. In another example embodiment, the threshold reflects a relative ranking between accounts; for example, only the accounts having the top 10 account scores are suggested, or only the accounts in the top 50% of account scores are suggested.

A lead scoring module 310 acts to generate a score for each potential lead generated by the lead generator 302. The score signifies the likelihood that the user will have interest in adding the lead to the tool data store 208 to be utilized by the tool to provide insights. The score may be based on a number of inputs. As depicted in FIG. 3, inputs may include both generated accounts from the account generator 300 and generated leads from the lead generator 302. This is because user interaction with accounts can affect the score for a lead associated with the account. For example, even if a user never interacts with a particular contact for a particular company, if the user interacts a lot with the company in general, the lead scoring module 310 may still assign a high score to the lead because the user is likely to have interest in gaining insights into the lead.

As with the account scoring module 304, while not pictured in FIG. 3, information may be obtained from other inputs as well, and used to affect the score assigned by the account scoring module 304. One example of another input is general Internet information, which may be used to, for example, filter or weight usage information on companies and/or contacts. For example, if a company is mentioned prominently in recent news articles, usage information showing interaction with employees of that company may be weighted higher than usage information showing interaction with employees of a company that is not mentioned prominently in recent news articles.

Another example of an additional input from which information may be obtained is usage information from partner services. A partner service may have information that, for example, is not available to the social networking service 120. For example, a search engine service may partner with the social networking service 120 and/or the tool and provide general search engine result information which can be used to, for example, filter or weight usage information on companies and/or contacts.

Thus, the lead scoring module 310 can utilize input from a number of different sources to provide the score to each potential account generated by the lead generator 302. In addition to the source of the input to the lead scoring module 310 being varied, the type of input information can be varied as well. In the case of social networking service usage information, for example, the information may include an identification of profiles visited by the user, the amount of time the user spent visiting each profile, the number of times the user visited each profile, the actions taken by the user within the social networking service 120 while viewing the profile (e.g., clicking on certain fields or links), identifications of communications sent to or from the potential accounts and/or potential contacts, the number of times such communications were sent or received, the amount of time the user spent reading or writing such communications, etc.

In an example embodiment, the score can be calculated in a manner that varies based on the user. For example, certain users may have certain characteristics that might make certain types of information more relevant to the scoring of how likely the user is to want to get insights regarding a certain lead. As an example, information about the user obtained by a user profile may indicate that the user is a VP of sales. The system may determine that VPs of sales are more likely to want to get insights about profiles they have viewed briefly than users having different job titles (who may request more time to be spent viewing a profile before insights become relevant). As such, the weighting of the inputs and/or scoring can be based, at least partially, on user-specific information.

The output of the lead scoring module 310 is a set of scores for the potential leads generated by the lead generator 302. These scores may then be sent to a lead ranker 312, which then may place the potential leads in order based on the scores. Thus, leads with scores reflecting a higher likelihood of user interest in insights for the lead are ranked higher than leads with scores reflecting a lower likelihood of user interest in insights for the lead.

A lead threshold comparer 314 can then take these rankings and compare them to a threshold to determine a final list of suggested leads. This threshold may be specified in a number of different ways. In one example embodiment, the threshold reflects a particular score which, if the lead score meets or exceeds the particular score, the corresponding lead is suggested. In another example embodiment, the threshold reflects a relative ranking between leads, for example, only the leads having the top 10 lead scores are suggested, or only the leads in the top 50% of lead scores are suggested.

Once the suggested accounts and/or leads are loaded into the tool data store 208, they can be used for insights, recommendations, or any other purpose deemed necessary by the tool 104.

In one example embodiments, information on suggested accounts and/or leads from the tool data store 208 are fed to one or more CRM systems 100A, 100B. Thus while the tool 104 may import accounts and contacts from the CRM system 102 and utilize such imported CRM entities to provide insights, the tool 104 is also able to feed suggested accounts and/or contacts derived from the social network service usage information to the one or more CRM systems 100A, 100B. This allows both the tool 104 and the CRM systems 100A, 100B to gain additional robustness. In an example embodiment, this information about the sales tool entities may be passed via an iframe, allowing the sales tool to maintain “ownership” of the entities themselves while still serving information about the entities to the CRM system 102.

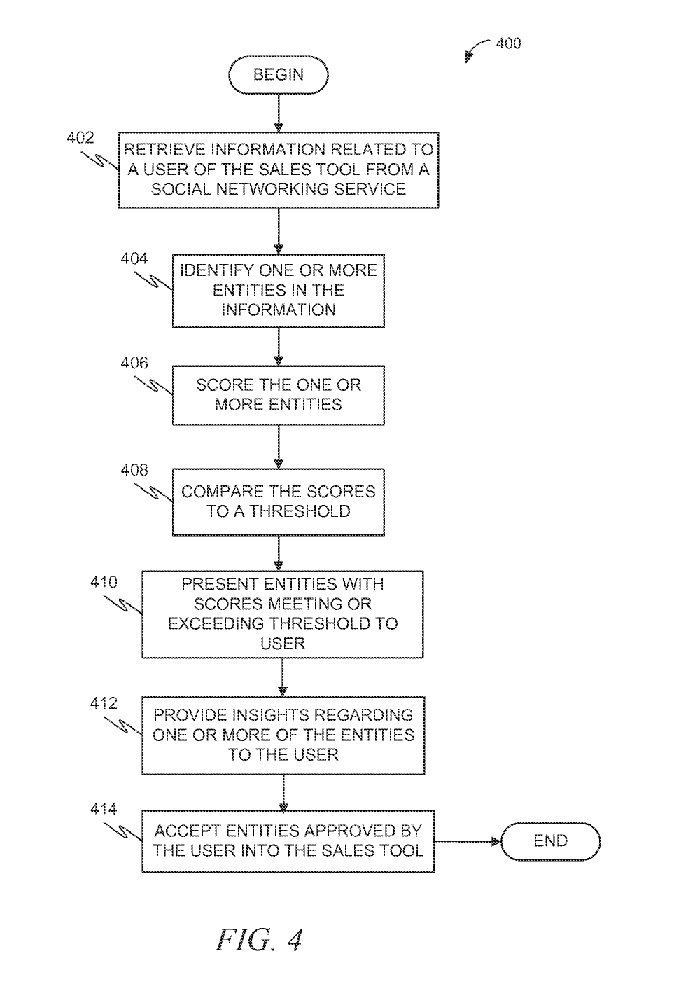

FIG. 4 is a flow diagram illustrating a method 400 for suggesting entries in a sales tool in accordance with an example embodiment. This method 400 may be performed during onboarding of a user in a sales tool. At operation 402, information related to a user of the sales tool is retrieved from a social networking service 120. At operation 404, one or more entities are identified in the information. The identified entities can include, for example, accounts and/or contacts. At operation 406, the one or more identified entities are scored. The score may signify the likelihood that the user will have interest receiving insights about each entity. At operation 408, the scores are compared to a threshold. At operation 410, entities whose scores meet or exceed the threshold are presented to the user for approval. At operation 412, any entities approved by the user are accepted as entries into the sales tool. At operation 414, one or more insights are provided to the user regarding one or more of the entries.

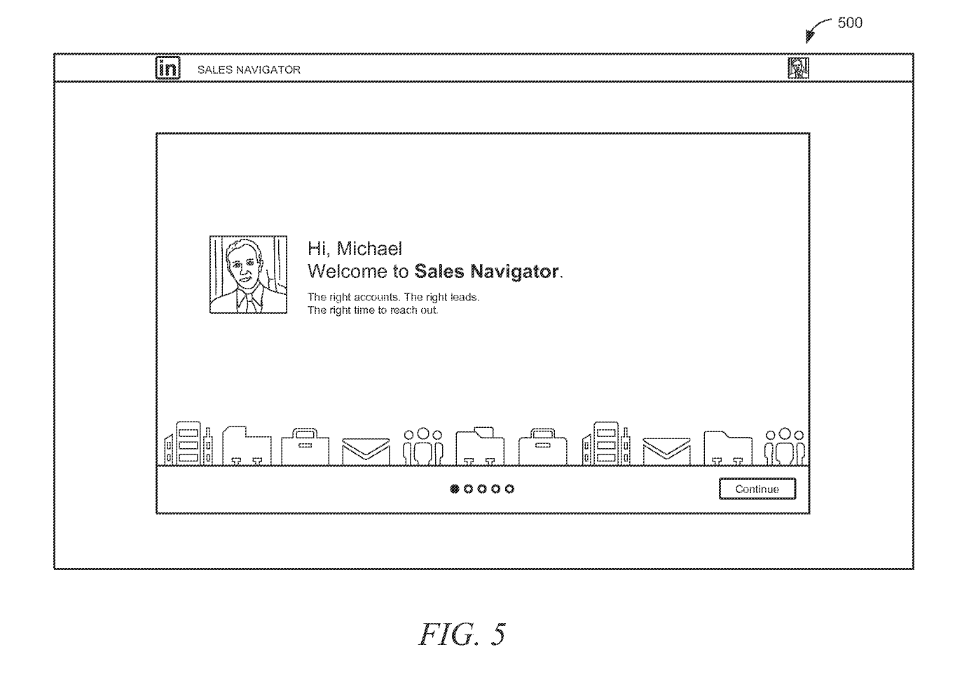

FIG. 5 is a screen capture illustrating a welcome screen 500 of a sales tool in accordance with an example embodiment. Here the user (Michael) is identified and the name of the sales tool (here, sales navigator) is shown.

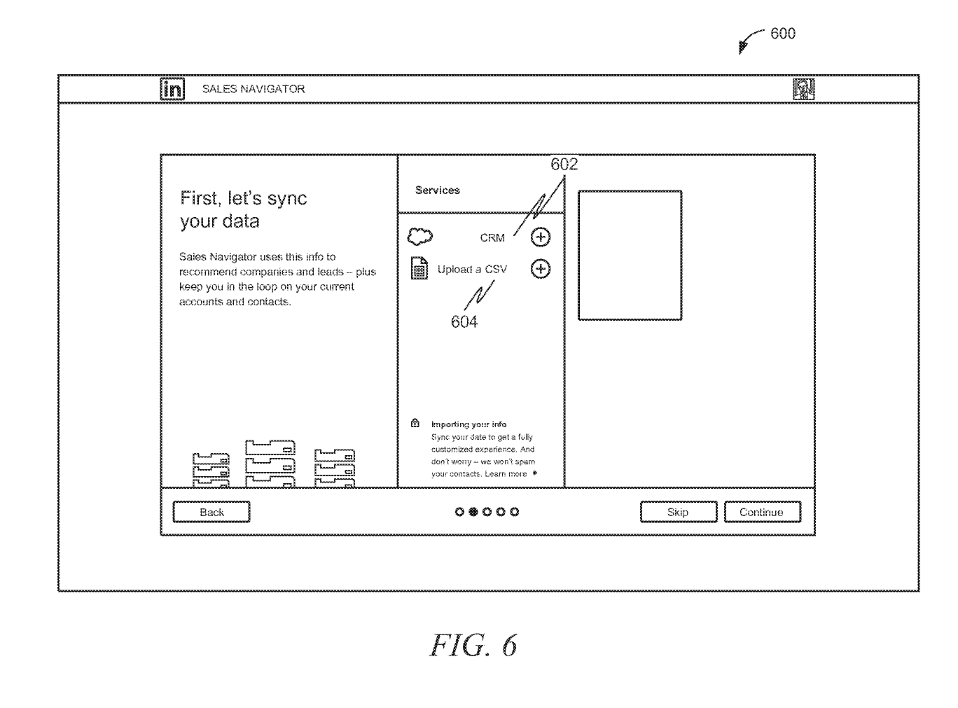

FIG. 6 is a screen capture illustrating a data synchronization screen 600 of the sales tool in accordance with an example embodiment. Here, the user is presented with the option of importing data from one or more CRMs 602 as well as uploading a comma-separated value (CSV) file 604.

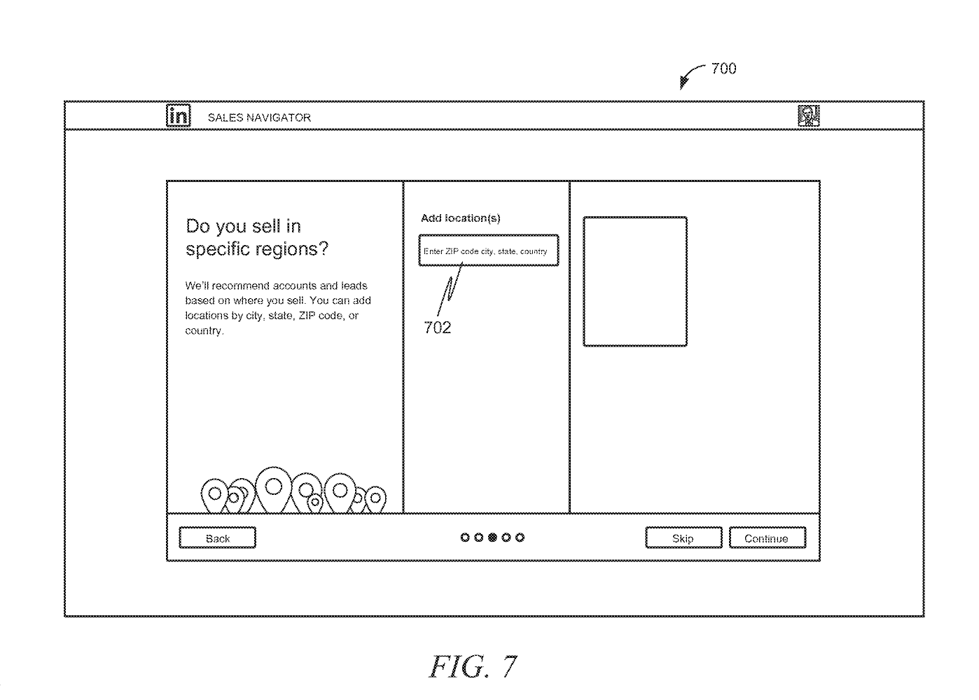

FIG. 7 is a screen capture illustrating a first user input screen 700 of the sales tool in accordance with an example embodiment. Here, the user is prompted to add a location 702 that he or she sells into. As described earlier, this information may be used to customize the weights of the scoring of accounts and/or leads suggested by the sales tool, or otherwise affect which accounts and/or leads are suggested to this particular user.

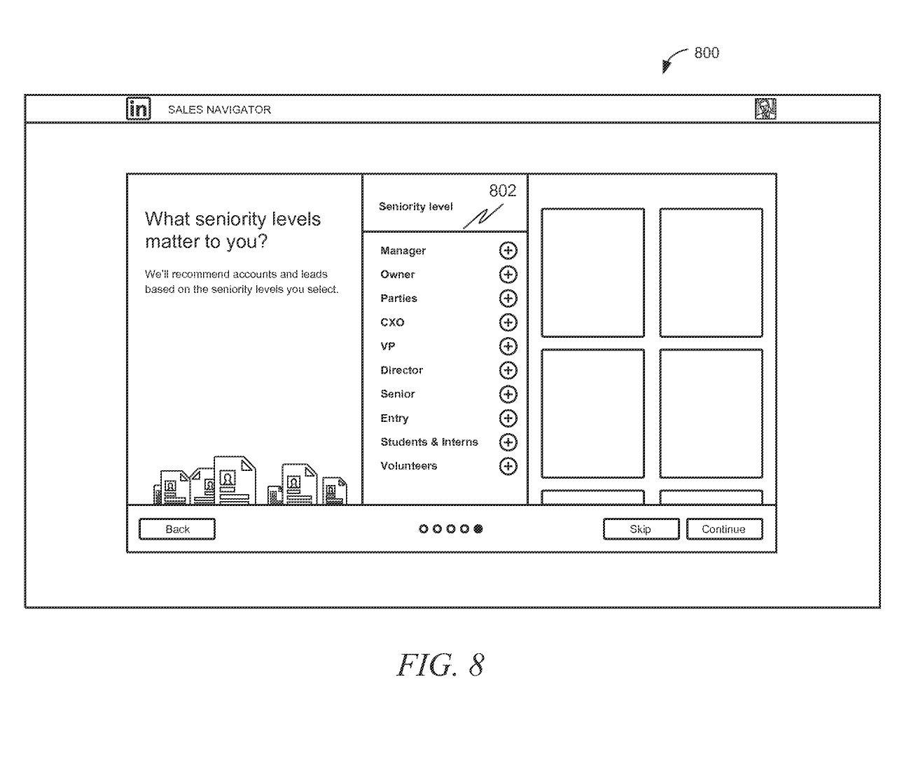

FIG. 8 is a screen capture illustrating a second user input screen 800 of the sales tool in accordance with an example embodiment. Here, the user is prompted to select one or more seniority levels 802 that matter to the user. As described earlier, this information may be used to customize the weights of the scoring of accounts and/or leads suggested by the sales tool, or otherwise affect which accounts and/or leads are suggested to this particular user.

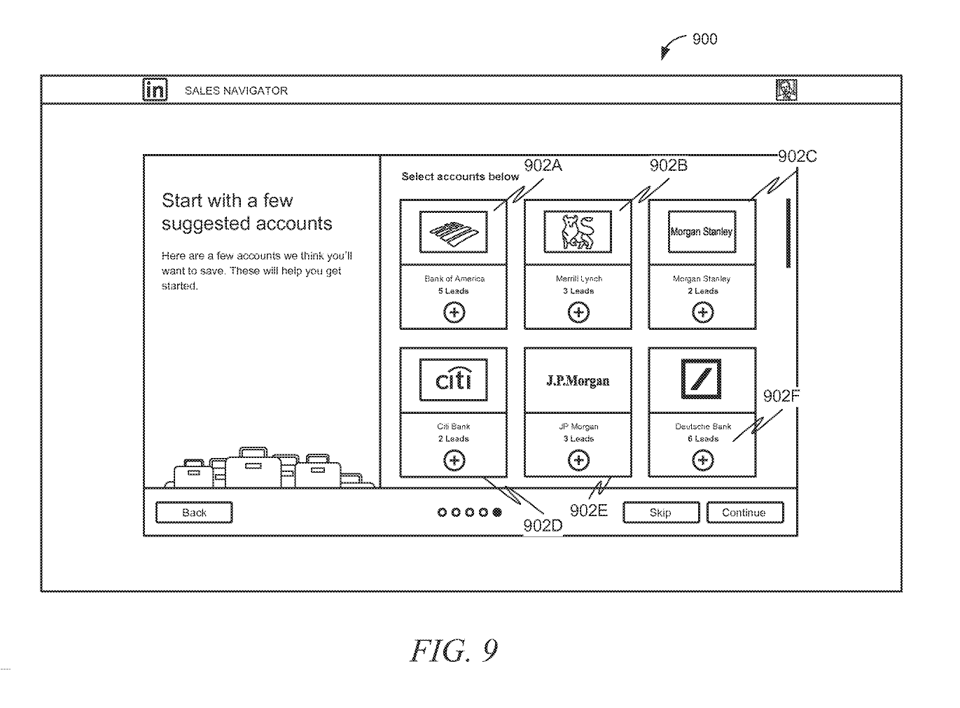

FIG. 9 is a screen capture illustrating a suggested accounts screen 900 of the sales tool in accordance with an example embodiment. Here, the system has suggested accounts 902A-902F (more may have been suggested but may simply not be visible on this screen unless the user scrolls down). Within each account, specific leads 904A-904F may also be suggested, which may be displayed by the user selecting on the various buttons 906A-906F.

### Example Mobile Device

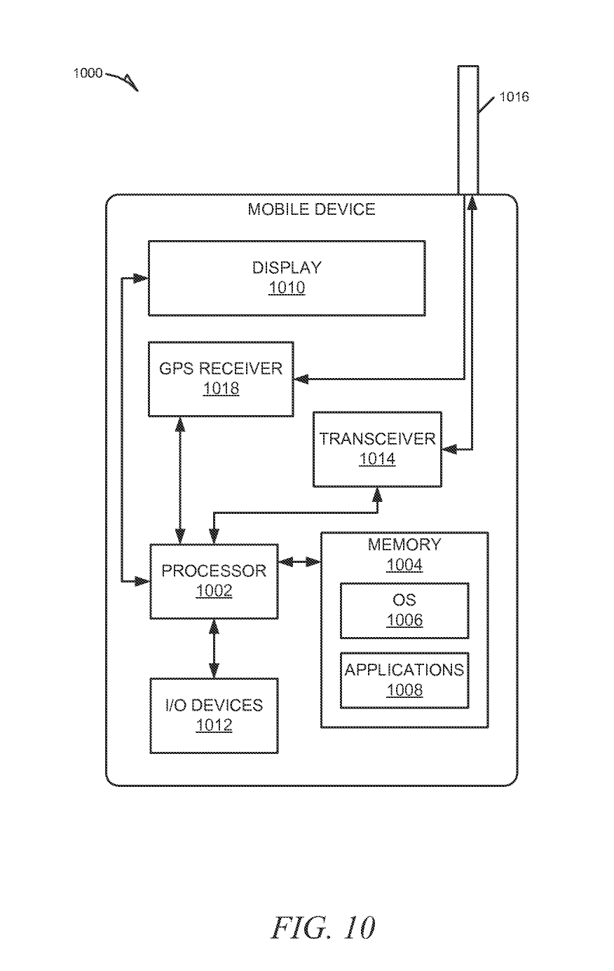

FIG. 10 is a block diagram illustrating a mobile device 1000, according to an example embodiment. The mobile device 1000 can include a processor 1002. The processor 1002 can be any of a variety of different types of commercially available processors 1002 suitable for mobile devices 1000 (for example, an XScale architecture microprocessor, a microprocessor without interlocked pipeline stages (MIPS) architecture processor, or another type of processor 1002). A memory 1004, such as a random access memory (RAM), a flash memory, or other type of memory, is typically accessible to the processor 1002. The memory 1004 can be adapted to store an operating system (OS) 1006, as well as application programs 1008. The processor 1002 can be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a Global Positioning System (GPS) receiver 1018 can also make use of the antenna 1016 to receive GPS signals.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors 1002 can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor 1002 or other programmable processor 1002) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 1002 configured using software, the general-purpose processor 1002 can be configured as respective different hardware-implemented modules at different times. Software can accordingly configure a processor 1002, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation, and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors 1002 that are temporarily configured (e.g., by software) or permanently configured to perform the relevant operations. Whether temporarily or permanently configured, such processors 1002 can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or processors 1002 or processor-implemented modules. The performance of certain of the operations can be distributed among the one or more processors 1002, not only residing within a single machine, but deployed across a number of machines. In some example embodiments, the processor 1002 or processors 1002 can be located in a single location (e.g., within a home environment, an office environment or as a server farm), while in other embodiments the processors 1002 can be distributed across a number of locations.

The one or more processors 1002 can also operate to support performance of the relevant operations in a “cloud computing” environment or as a “software as a service” (SaaS). For example, at least some of the operations can be performed by a group of computers (as examples of machines including processors 1002), these operations being accessible via a network (e.g., the Internet) and via one or more appropriate interfaces (e.g., application program interfaces (APIs).)

### Electronic Apparatus and System

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor 1002, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors 1002 executing a computer program to perform functions by operating on input data and generating output. Method operations can also be performed by, and apparatus of example embodiments can be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor 1002), or a combination of permanently and temporarily configured hardware can be a design choice. Below are set out hardware (e.g., machine) and software architectures that can be deployed, in various example embodiments.

### Example Machine Architecture and Machine-Readable Medium

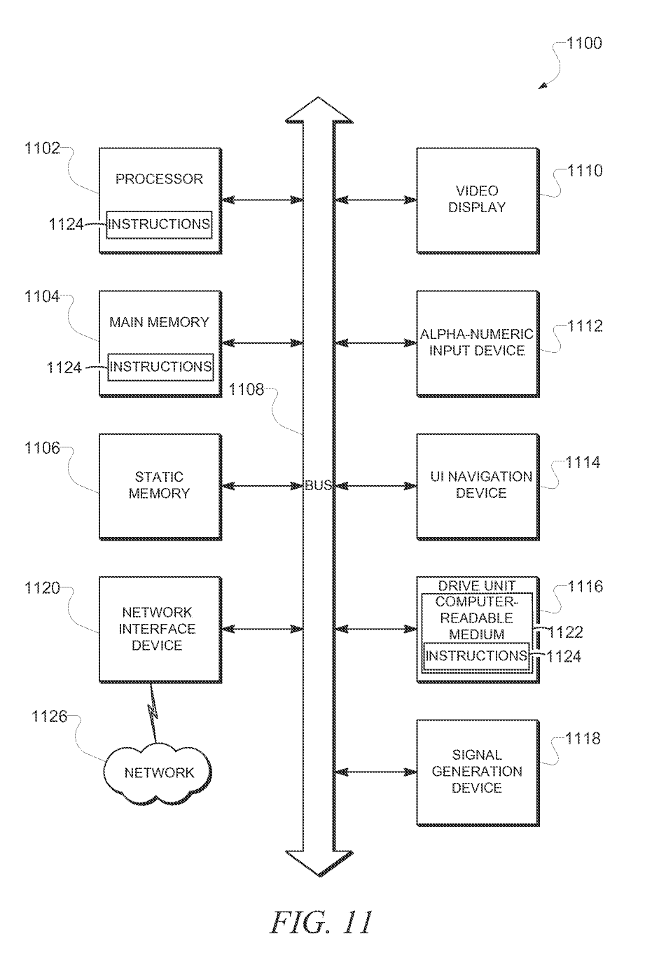

FIG. 11 is a block diagram of machine in the example form of a computer system 1100 within which instructions, for causing the machine to perform any one or more of the methodologies discussed herein, can be executed. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a CPU, a graphics processing unit (GPU), or both), a main memory 1104 and a static memory 1106, which communicate with each other via a bus 1108. The computer system 1100 can further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation device 1114 (e.g., a mouse), a disk drive unit 1116, a signal generation device 1118 (e.g., a speaker), and a network interface device 1120.

### Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 can also reside, completely or at least partially, within the main memory 1104 and/or within the processor 1102 during execution thereof by the computer system 1100, the main memory 1104 and the processor 1102 also constituting machine-readable media 1122.

While the machine-readable medium 1122 is shown in an example embodiment to be a single medium, the term “machine-readable medium” can include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions 1124 for execution by the machine and that cause the machine to perform any one or more of the methodologies of the present disclosure or that is capable of storing, encoding or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1124 can further be transmitted or received over a communications network 1126 using a transmission medium. The instructions 124 can be transmitted using the network interface device 1120 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1124 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
receiving a request to onboard a first user to a software tool;
obtaining usage information related to the first user from a social networking service, wherein the usage information includes information on which profile web pages within the social networking site the first user viewed and how many times each of the profile web pages was viewed by the first user, the social networking site having a plurality of different profile web pages;
generating one or more entities in the software tool based on the usage information from the social networking site;
calculating a score for each of the one or more entities, the score for a particular entity being calculated based on the number of times a profile web page profile in the social networking site for the particular entity was viewed by the first user, an amount of time the profile web pare was viewed by the first user, one or more computer commands executed by the first user while viewing the profile web page, and a number of communications sent between the first user and the particular entity;
ranking the one or more entities based on the calculated score for each of the one or more entities;
adding the one or more entities as entries in the software tool based on the ranking;
performing a database search, on a news article database, for each of the one or more entities to identify any recent news articles tracked by the social networking site that mention any of the one or more entities; and
providing results of the news article database search to the first user.

2. The method of claim 1, wherein the adding includes:
presenting a subset of the one or more entities to the first user;
receiving feedback from the first user regarding the subset of the one or more entities; and
determining which of the one or more entities to add as entries in the software tool based on the feedback.

3. The method of claim 2, wherein the subset of the one or more entities is determined based on the ranking.

4. The method of claim 3, wherein the subset of the one or more entities is further determined by comparing the calculated score for one or more of the entities to a threshold.

5. The method of claim 4, wherein the threshold is absolute.

6. The method of claim 4, wherein the threshold is relative.

7. The method of claim 1, wherein the one or more entities include accounts and/or leads.

8.-9. (canceled)

10. The method of claim 1, wherein the usage information includes information on how long the first user viewed each profile web page.

11. The method of claim 1, wherein the usage information includes communications sent between the first user and other entities in the social networking site via an in-network communications platform of the social networking service.

12. The method of claim 1, wherein the entities are supplemented with customer relationship management (CRM) entities from a CRM system.

13. The method of claim 1, further comprising sending information about the one or more entities added to the software tool to a CRM system.

14. A computer tool comprising:
a data store;
an onboarding module comprising:
a social networking service interface configured to obtain usage information related to the first user from a social networking site, wherein the usage information includes information on which profile web pages in the social networking site the first user viewed and how many times each of the profile web pages was viewed by the first user, the social networking site having a plurality of different profile web pages;
a social networking information analyzer configured to:
generate one or more entities in the computer tool based on the usage information from the social networking service;
calculate a score for each of the one or more entities, the score for a particular entity being calculated based on the number of times a profile web page in the social networking site for the particular entity was viewed by the first user, an amount of time the profile web page was viewed by the first user, one or more computer commands executed by the first user while viewing the profile web page, and a number of communications sent between the first user and the particular entity;
rank the one or more entities based on the calculated score for each of the one or more entities; and
add the one or more entities as entries in the computer tool based on the ranking.

15. The computer tool of claim 14, further comprising an insight module configured to locate any recent news articles tracked by the social networking site that involve the one or more added entities and provide insights to the first user for the one or more added entities, the insights including the located recent news articles.

16. The computer tool of claim 14, further comprising a CRM interface configured to add entries to the computer tool based on CRM entities imported from a CRM system.

17. The computer tool of claim 14, wherein the social networking information analyzer includes:
an account generator configured to generate accounts based on the usage information;
a lead generator configured to generate leads based on the usage information;
an account scoring module configured to generate a score for each of the generated accounts based on the usage information and based on the leads; and
a lead scoring module configured to generate a score for each of the generated leads based on the usage information and based on the accounts.

18. A non-transitory machine-readable storage medium having instruction data to cause a machine to perform the following operations:
receiving a request to onboard a first user to a software tool;
obtaining usage information related to the first user from a social networking service, wherein the usage information includes information on which profile web pages within the social networking site the first user viewed and how many times each of the profile web pages was viewed by the first user, the social networking site having a plurality of different profile web pages;
generating one or more entities in the software tool based on the usage information from the social networking site;
calculating a score for each of the one or more entities, the score for a particular entity being calculated based on the number of times a profile web page in the social networking site for the particular entity was viewed by the first user, an amount of time the profile web page was viewed by the first user, one or more computer commands executed by the first user while viewing the profile web page, and a number of communications sent between the first user and the particular entity;
ranking the one or more entities based on the calculated score for each of the one or more entities;
adding the one or more entities as entries in the software tool based on the ranking;
performing a database search, on a news article database, for each of the one or more entities to identify any recent news articles tracked by the social networking site that mention any of the one or more entities; and
providing results of the news article database search to the first user.

19. The non-transitory machine-readable storage medium of claim 18, wherein the entities are supplemented with customer relationship management (CRM) entities from a CRM system.

20. The non-transitory machine-readable storage medium of claim 18, wherein the operations further comprise sending information about the one or more entities added to the software tool to a CRM system.
